(19) United States
(12) Patent Application Publication
(10) Pub. No.: US 2025/0231777 A1
(43) Pub. Date: Jul. 17, 2025

(54) SYSTEMS AND METHODS FOR WORKSPACE REORGANIZATION TO OPTIMIZE USER PRODUCTIVITY

(71) Applicant: Dell Products L.P., Round Rock, TX (US)

(72) Inventors: Jyoti J. LUU, Austin, TX (US); Ryan N. COMER, Round Rock, TX (US); David O. GARNER, Cedar Park, TX (US)

(73) Assignee: Dell Products L.P., Round Rock, TX (US)

(21) Appl. No.: 18/413,845

(22) Filed: Jan. 16, 2024

(51) Int. Cl. G06F 9/451; G06Q 10/0633

(52) U.S. Cl. CPC G06F 9/451; G06Q 10/0633

(57) ABSTRACT

An information handling system may include a processor and a workspace observer comprising a program of instructions embodied in non-transitory computer-readable media communicatively coupled to the processor. The workspace observer may be configured to when read and executed by the processor monitor interactions by a user with an existing user workspace of the information handling system, based on the interactions, generate a workspace efficiency indicative of an efficiency at which the user completes one or more tasks using the existing user workspace, and if the workspace efficiency is below a threshold efficiency, generate a new user workspace for the user to replace the existing user workspace.

### TECHNICAL FIELD

The present disclosure relates in general to information handling systems, and more particularly to reorganization of a user workspace in order to optimize user productivity.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Users of information handling systems have different needs and behaviors in their everyday work routines. The content and the manner in which the content is displayed to a user impacts how well a user can accomplish tasks. For instance, if all the applications a user needs to execute are pinned to a dock, a user may efficiently find and execute applications the user may need. A “dock” may comprise a portion of a user interface screen of an information handling system that remains readily available (e.g., in some instances may always be visible) and includes icons for various applications and tasks such that a user can quickly launch such applications or tasks by interacting (e.g., clicking, double-clicking) with an appropriate icon.

The composition of a user's workspace can either increase or decrease their productivity depending on the current layout and the user's context. A “workspace” may be defined as a collection of the user's applications and data, how the applications and data are represented in a graphical interface for the user, and how the user interacts with the applications and data. At any point in time a user's workspace might be composed in such a way that leads to suboptimal productivity. For example, while in a team meeting a user may realize he or she does not have the application the rest of their team is collaborating on which causes them to lose focus while trying to access the application. This is a dynamic problem as the user's context and needs may constantly change. There is no single consistent solution presently available that solves this problem.

### SUMMARY

In accordance with the teachings of the present disclosure, the disadvantages and problems associated with traditional approaches to maintaining a user workspace may be reduced or eliminated.

In accordance with embodiments of the present disclosure, an information handling system may include a processor and a workspace observer comprising a program of instructions embodied in non-transitory computer-readable media communicatively coupled to the processor. The workspace observer may be configured to when read and executed by the processor monitor interactions by a user with an existing user workspace of the information handling system, based on the interactions, generate a workspace efficiency indicative of an efficiency at which the user completes one or more tasks using the existing user workspace, and if the workspace efficiency is below a threshold efficiency, generate a new user workspace for the user to replace the existing user workspace.

In accordance with these and other embodiments of the present disclosure, a method may include monitoring interactions by a user with an existing user workspace of an information handling system, based on the interactions, generating a workspace efficiency indicative of an efficiency at which the user completes one or more tasks using the existing user workspace, and if the workspace efficiency is below a threshold efficiency, generating a new user workspace for the user to replace the existing user workspace.

In accordance with these and other embodiments of the present disclosure, An article of manufacture may include a non-transitory computer-readable medium and computer-executable instructions carried on the computer-readable medium, the instructions readable by a processor, the instructions, when read and executed, for causing the processor to: monitor interactions by a user with an existing user workspace of an information handling system; based on the interactions, generate a workspace efficiency indicative of an efficiency at which the user completes one or more tasks using the existing user workspace; and if the workspace efficiency is below a threshold efficiency, generate a new user workspace for the user to replace the existing user workspace.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure; and

FIG. 2 illustrates a block diagram detailing an example method for optimizing a user workspace, in accordance with embodiments of the present disclosure.

### DETAILED DESCRIPTION

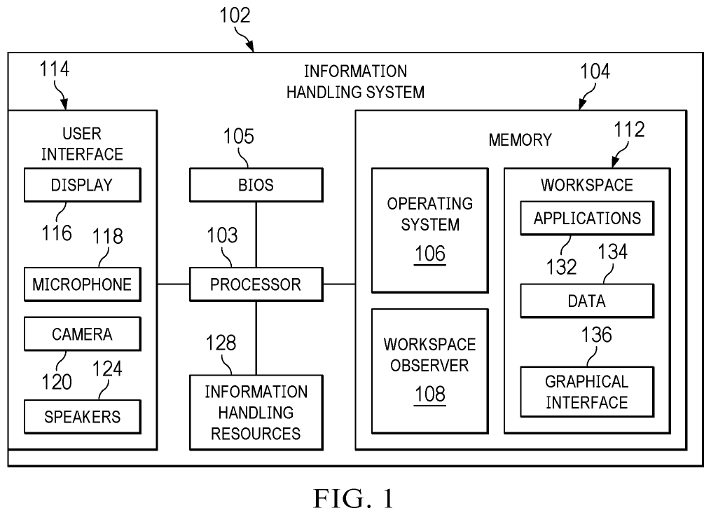

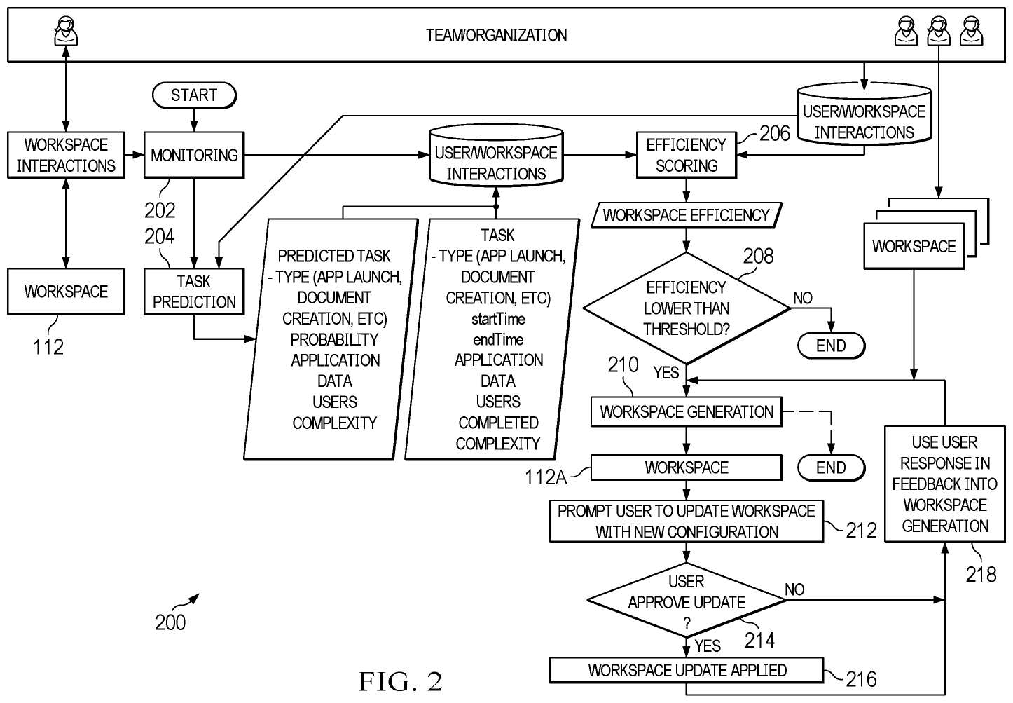

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

FIG. 1 illustrates a block diagram of selected components of an example information handling system 102, in accordance with embodiments of the present disclosure. In some embodiments, information handling system 102 may comprise or be an integral part of a server. In some embodiments, information handling system 102 may be a personal computer (e.g., a desktop computer or a portable computer). In other embodiments, information handling system 102 may comprise a mobile device (e.g., a smart phone, a tablet computing device, a handheld computing device, a personal digital assistant, or any other device that may be readily transported on a person of a user of such mobile device).

As depicted in FIG. 1, information handling system 102 may include a processor 103, a memory 104 communicatively coupled to processor 103, a user interface 114 communicatively coupled to processor 103, and one or more information handling resources 128 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, and/or another component of information handling system 102.

Memory 104 may be communicatively coupled to processor 103 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to its associated information handling system 102 is turned off.

As shown in FIG. 1, memory 104 may have stored therein an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface. Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

As shown in FIG. 1, memory 104 may also have stored therein a workspace observer 108. Workspace observer 108 may comprise one or more programs of instructions, which may run on operating system 106 as an application program or utility, and may be configured to monitor a context of a user of information handling system 102 and based on such monitoring, dynamically compose the user's workspace based on the user's context and workspace usage characteristics, as described in greater detail below.

As further shown in FIG. 1, memory 104 may also have stored therein a workspace 112 for a user of information handling system 102. Workspace 112 may comprise a database, map, list, table, and/or other suitable data structure defining applications 132 installed and available to the user, data 134 available to the user, and a graphical interface 136 associated with the user (e.g., displayed to display 116). Graphical interface 136 may include active windows displayed to the user, icons associated with applications and/or files displayed to the user including any icons present in a dock of graphical interface 136, and/or any other graphical and/or alphanumeric information displayed to the user.

A BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105.

User interface 114 may comprise any instrumentality or aggregation of instrumentalities by which a user may interact with information handling system 102. For example, user interface 114 may permit a user to input data and/or instructions into information handling system 102 (e.g., via a keypad, keyboard, touch screen, microphone, camera, and/or other data input device), and/or otherwise manipulate information handling system 102 and its associated components. User interface 114 may also permit information handling system 102 to communicate data to a user (e.g., via a display device, speaker, and/or other data output device). As shown in FIG. 1, user interface 114 may include one or more of a display 116, microphone 118, camera 120, and two or more speakers 124.

Display 116 may comprise any suitable system, device, or apparatus configured to display human-perceptible graphical data and/or alphanumeric data to a user. For example, in some embodiments, display 116 may comprise a liquid crystal display.

Microphone 118 may comprise any system, device, or apparatus configured to convert sound incident at microphone 118 to an electrical signal that may be processed by processor 103. In some embodiments, microphone 118 may include a capacitive microphone (e.g., an electrostatic microphone, a condenser microphone, an electret microphone, a microelectromechanical systems (MEMS) microphone, etc.) wherein such sound is converted to an electrical signal using a diaphragm or membrane having an electrical capacitance that varies based on sonic vibrations received at the diaphragm or membrane.

Camera 120 may comprise any system, device, or apparatus configured to record images (moving or still) into one or more electrical signals that may be processed by processor 103.

A speaker 124 may comprise any system, device, or apparatus configured to produce sound in response to electrical audio signal input.

In addition to processor 103, memory 104, BIOS 105, and user interface 114, information handling system 102 may include one or more other information handling resources 128. Such an information handling resource 128 may include any component system, device or apparatus of an information handling system, including without limitation, a processor, bus, memory, I/O device and/or interface, storage resource (e.g., hard disk drives), network interface, electro-mechanical device (e.g., fan), display, power supply, and/or any portion thereof. An information handling resource may comprise any suitable package or form factor, including without limitation an integrated circuit package or a printed circuit board having mounted thereon one or more integrated circuits.

In operation, workspace observer 108 may dynamically compose a user's workspace 112 based on the user's context and workspace usage characteristics based on monitoring the context of the user and how the user interacts with workspace 112. For example, the productivity of a current workspace composition may be calculated by considering the time it takes for the user to complete tasks. Workspace observer 108 may monitor user interaction with workspace 112 to determine the start time and end time of independent tasks. Based on the time it takes the user to complete tasks, workspace observer 108 may calculate a score for the current workspace composition.

Workspace observer 108 may also determine predicted tasks for the user based on tasks that similar users complete in an organization to which the user belongs. Workspace observer 108 predicts when the predicted tasks may need to be executed by the user, which may trigger a new composition of the current workspace 112.

Workspace observer 108 may also consider the workspace composition and user interactions across all other users on the team or organization. A goal of workspace observer 108 may be to discover common “good” configurations across the team or organization and combine that with personalized preferences for individual users to create an optimal workspace 112.

FIG. 2 illustrates a block diagram detailing an example method 200 for optimizing a user workspace, in accordance with embodiments of the present disclosure. According to some embodiments, method 200 may begin at step 202. As noted above, teachings of the present disclosure may be implemented in a variety of configurations of information handling system 102.

At step 202, workspace observer 108 may monitor a user's interaction with workspace 112 and, based thereon, determine metrics associated with the user's execution of tasks, including for each task the type of task (e.g., application launch, document creation, etc.), time needed to execute the task, application data associated with the task, users (other than the user) associated with the task, a complexity associated with the task, and/or other metrics associated with the task, and store such metrics.

At step 204, workspace observer 108 may, based on the monitoring and based on user/workspace interactions of other users in the same team and/or organization as the user, predict one or more predicted tasks likely to be executed by the user, and determine metrics associated with each predicted task, including for each predicted task the type of task (e.g., application launch, document creation, etc.), probability of execution of the predicted task, application data associated with the predicted task, users (other than the user) associated with the predicted task, a complexity associated with the predicted task, and/or other metrics associated with the predicted task. Workspace observer 108 may further store such predicted tasks and their associated metrics.

At step 206, based on the observed tasks, predicted tasks, and their associated metrics, as well as metrics from user/workspace interactions from other users in the team/organization, workspace observer 108 may perform efficiency scoring to generate a workspace efficiency score for the user workspace 112. The score may be computed in any suitable manner, and many different scoring approaches may be used, and thus are beyond the scope of this disclosure.

At step 208, workspace observer 108 may determine if the workspace efficiency is lower than an efficiency threshold. If the workspace efficiency is lower than an efficiency threshold, method 200 may proceed to step 210. Otherwise, method 200 may end.

At step 210, workspace observer 108 may perform workspace generation, to generate a new proposed workspace 112A which may improve the workspace efficiency for executing observed tasks and predicted tasks over the existing workspace 112. In some embodiments, workspace generation may be influenced by workspaces of other users in the team/organization (e.g., by workspaces having more efficient configurations).

At step 212, workspace observer 108 may prompt the user to update the existing workspace 112 with the new proposed workspace 112A. At step 214, workspace observer 108 may determine whether the user approves of the update. If the user disapproves of the update, method 200 may proceed to step 216. Otherwise, if the user approves the update, method 200 may proceed to step 218.

At step 216, workspace observer 108 may replace the existing workspace 112 with new proposed workspace 112A.

At step 218, workspace observer 108 may use the user response as feedback to workspace generation. For example, the user prompt at step 212 may allow a user to selectively approve and disapprove of individual proposed changes between existing workspace 112 and new proposed workspace 112A, and workspace observer 108 may use the proposed changes disapproved by the user in order to propose another new proposed workspace 112A. Accordingly, after completion of step 216, method 200 may proceed again to step 210, although method 200 may end after workspace generation at step 210 is executed a second time in response to user feedback. Further, the user response feedback may also be factored into future workspace generations, to build workspaces in accordance with learning of user preferences with regards to certain workspace changes.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using information handling system 102 or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor; and
a workspace observer comprising a program of instructions embodied in non-transitory computer-readable media communicatively coupled to the processor and configured to, when read and executed by the processor:
monitor interactions by a user with an existing user workspace of the information handling system;
based on the interactions, generate a workspace efficiency indicative of an efficiency at which the user completes one or more tasks using the existing user workspace; and
if the workspace efficiency is below a threshold efficiency, generate a new user workspace for the user to replace the existing user workspace.

2. The information handling system of claim 1, wherein the workspace efficiency is based on times required for the user to complete the one or more tasks using the existing user workspace.

3. The information handling system of claim 1, wherein the workspace observer is further configured to:
monitor interactions by other users with respective other user workspaces; and
generate the new user workspace based on the interactions by the user with the existing user workspace and based on the interactions by other users with respective other user workspaces.

4. The information handling system of claim 1, wherein the workspace observer is further configured to:
prompt the user to approve updating the existing user workspace with the new user workspace; and
replace the existing user workspace with the new user workspace if the user approves.

5. The information handling system of claim 4, wherein the workspace observer is further configured to generate another new user workspace if the user disapproves of updating the existing user workspace with the new user workspace.

6. A method comprising:
monitoring interactions by a user with an existing user workspace of an information handling system;
based on the interactions, generating a workspace efficiency indicative of an efficiency at which the user completes one or more tasks using the existing user workspace; and
if the workspace efficiency is below a threshold efficiency, generating a new user workspace for the user to replace the existing user workspace.

7. The method of claim 6, wherein the workspace efficiency is based on times required for the user to complete the one or more tasks using the existing user workspace.

8. The method of claim 6, further comprising:
monitoring interactions by other users with respective other user workspaces; and
generating the new user workspace based on the interactions by the user with the existing user workspace and based on the interactions by other users with respective other user workspaces.

9. The method of claim 6, further comprising:
prompting the user to approve updating the existing user workspace with the new user workspace; and
replacing the existing user workspace with the new user workspace if the user approves.

10. The method of claim 9, further comprising generating another new user workspace if the user disapproves of updating the existing user workspace with the new user workspace.

11. An article of manufacture comprising:
a non-transitory computer-readable medium; and
computer-executable instructions carried on the computer-readable medium, the instructions readable by a processor, the instructions, when read and executed, for causing the processor to:
monitor interactions by a user with an existing user workspace of an information handling system;
based on the interactions, generate a workspace efficiency indicative of an efficiency at which the user completes one or more tasks using the existing user workspace; and
if the workspace efficiency is below a threshold efficiency, generate a new user workspace for the user to replace the existing user workspace.

12. The article of claim 11, wherein the workspace efficiency is based on times required for the user to complete the one or more tasks using the existing user workspace.

13. The article of claim 11, the instructions for further causing the processor to:
monitor interactions by other users with respective other user workspaces; and
generate the new user workspace based on the interactions by the user with the existing user workspace and based on the interactions by other users with respective other user workspaces.

14. The article of claim 11, the instructions for further causing the processor to:
prompt the user to approve updating the existing user workspace with the new user workspace; and
replace the existing user workspace with the new user workspace if the user approves.

15. The article of claim 14, the instructions for further causing the processor to generate another new user workspace if the user disapproves of updating the existing user workspace with the new user workspace.
